(19) United States
(12) Patent Application Publication
(10) Pub. No.: US 2025/0119906 A1
(43) Pub. Date: Apr. 10, 2025

(54) METHODS, COMMUNICATIONS DEVICES, AND INFRASTRUCTURE EQUIPMENT

(71) Applicant: Sony Group Corporation, Tokyo (JP)

(72) Inventors: Yassin Aden AWAD, Basingstoke (GB); Vivek SHARMA, Basingstoke (GB); Yuxin WEI, Basingstoke (GB); Hideji WAKABAYASHI, Basingstoke (GB)

(73) Assignee: Sony Group Corporation, Tokyo (JP)

(21) Appl. No.: 18/729,900

(22) PCT Filed: Dec. 21, 2022
(86) PCT No.: PCT/EP2022/087258

§ 371 Date: Jul. 18, 2024

(30) Foreign Application Priority Data
Jan. 25, 2022 (EP) 22153309.4

(51) Int. Cl. H04W 72/1268; H04W 72/0457; H04W 72/51

(52) U.S. Cl. CPC H04W 72/1268; H04W 72/0457; H04W 72/51

(57) ABSTRACT

A method for operating a communications device in a wireless network involves determining when the device has uplink data to send. The device independently decides whether to use a device-based scheduling mode. If this mode is chosen, the device switches from a first bandwidth part (BWP) to a second BWP, which has greater bandwidth and includes both control and data resources. The device then sends scheduling information within the control resource, indicating its intent to transmit uplink data, and subsequently sends the uplink data within the data resource according to the scheduling information.

### BACKGROUND

### Field of Disclosure

The present disclosure relates to communications devices, infrastructure equipment and methods for the more efficient operation of a communications device in a wireless communications network.

The present application claims the Paris Convention priority from European patent application number EP22153309.4, filed on 25 Jan. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current future wireless communications networks, for example those which may be referred to as 5G or new radio (NR) systems/new radio access technology (RAT) systems or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems, as well as future generation communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit signals to and/or to receive signals from a wireless communications network via a wireless radio interface provided by the wireless communications network. The method comprises determining that the communications device has uplink data to transmit to the wireless communications network, and determining, independently from the wireless communications network, whether the communications device is to operate in accordance with a communications device based scheduling mode in order to transmit the uplink data. If the communications device determines that it is to operate in accordance with the communications device based scheduling mode in order to transmit the uplink data, the method comprises, as the communications device based scheduling mode, switching from a first bandwidth part, BWP, of the wireless radio interface to a second BWP of the wireless radio interface for transmission of the uplink data, wherein the second BWP has a greater bandwidth than the first BWP and comprises a control resource and a data resource, transmitting, to the wireless communications network within the control resource, scheduling information indicating that the communications device is to transmit at least part of the uplink data to the wireless communications network, and transmitting, to the wireless communications network within the data resource, the at least part of the uplink data in accordance with the transmitted scheduling information.

Embodiments of the present technique, which, in addition to methods of operating communications devices, relate to methods of operating infrastructure equipment, communications devices and infrastructure equipment, circuitry for communications devices and infrastructure equipment, wireless communications systems, computer programs, and computer-readable storage mediums, can allow for more efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates how different UEs can be assigned separate spatial-layer resources;

FIG. 5 illustrates how different UEs can be assigned separate frequency-domain resources;

FIG. 6 illustrates how different UEs can be assigned separate time-domain resources;

FIG. 7 shows an example of pre-assigned dedicated resources for UE-based scheduling comprising separate control and data resources;

FIG. 8 illustrates a portion of a wireless access interface, in which the system bandwidth comprises multiple bandwidth parts (BWPs), in accordance with certain aspects of the present disclosure;

FIG. 9 shows a part schematic, part message flow diagram representation of a wireless communications system comprising a communications device and an infrastructure equipment in accordance with embodiments of the present technique;

FIG. 10 illustrates an example of bandwidth adaptation comprising wider and narrower bandwidth parts, in accordance with embodiments of the present technique; and

FIG. 11 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

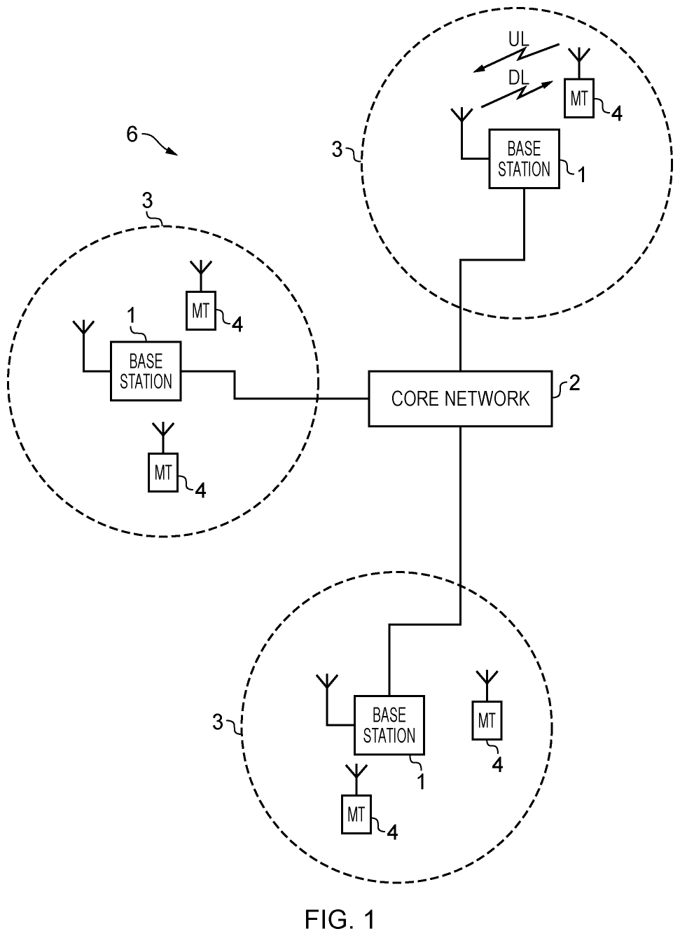

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

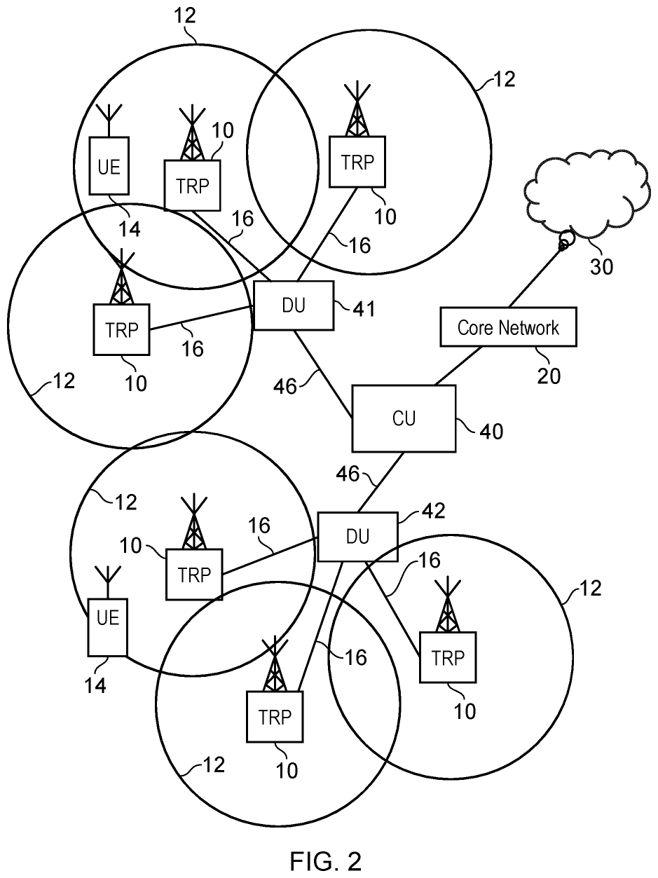

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

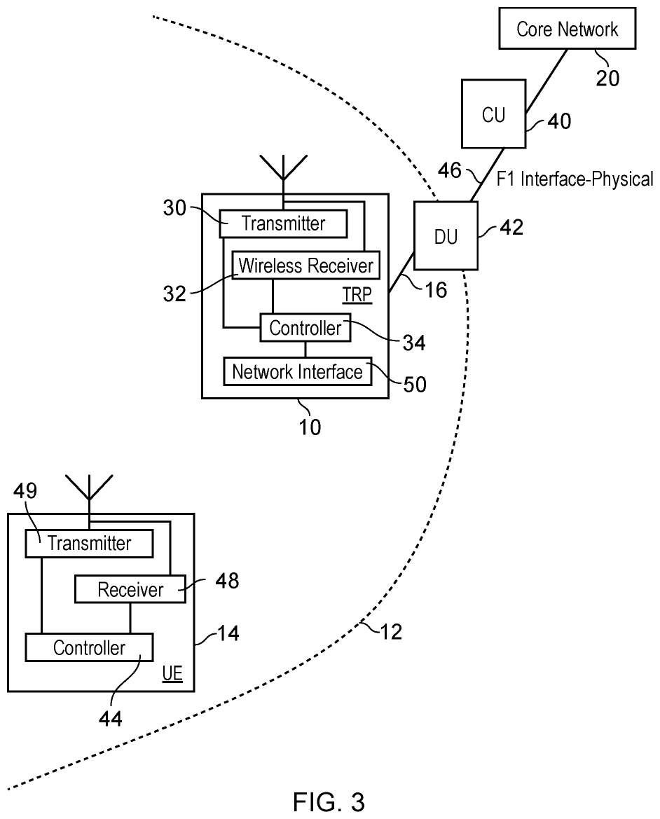

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

URLLC and eURLLC

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. in a 5G system. eURLLC is further enhanced as IIoT-URLLC [4], for which one of the objectives is to enhance UE feedback for Hybrid Automatic Repeat Request Acknowledgements (HARQ-ACK) for Physical Downlink Shared Channel (PDSCH) transmissions.

### Future 6G Wireless Communications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 2 and 3, where a significant number of additional features have been incorporated in different releases to provide new services and capabilities. Such services include eMBB, IIoT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS), Reduced Capability UEs, Vehicular Communications (V2X), Integrated Access and Backhaul (IAB), UE power saving, Non Terrestrial Networks (NTN), NR operation up to 71 GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide.

One of the areas for investigation for future mobile communications networks is uplink (UL) scheduling enhancements, which are expected to be required due to the increased number of services that require low latency communications and high reliability, as well as high throughput UL data transmissions from the terminal, like tactile internet, Audio-Video field production, and extended Reality (XR). In essence, it is proposed that a mobile terminal should be able to schedule unrestricted UL resources immediately after data arrives in its buffer for transmission, while taking into account the link adaptation parameters so that the transmissions are mostly ensured to be successful.

A typical use case (e.g. for broadcast TV production) is a camera transmitting a video stream using the User Data Protocol (UDP)/Internet Protocol (IP) protocol stack. In layer 2 of this protocol stack (L2), Radio Link Control-Unacknowledged Mode (RLC-UM) mode will be configured for UDP. Accordingly, dedicated (and probably regular) resources may be configured by the network, using techniques like periodic UL grant or configured grant. Such techniques are already developed and available.

As an example scenario, there might be a video algorithm which requires a camera not to transmit any uplink video frames if the view does not change. But as soon as the view changes, video codecs will have data available for transmission in L2 buffers. If traditional techniques are relied upon, the camera/UE must request UL resources before transmitting on the uplink. This likely involves additional signalling and latency which is detrimental to live production.

Further aspects of UL scheduling may be found in co-pending European patent application published under number EP3837895 [5], the contents of which are hereby incorporated by reference.

### Link Adaptation in Existing Mobile Communications Networks

The lower layers (MAC and physical layers) of a mobile communication system are designed to create a radio waveform used for conveying data between a transmitter and receiver given some expected radio propagation conditions between the communicating gNB and the UE. In traditional link-layer designs, these layers are designed to allow the radio-communication system to cope with a given degree of radio propagation impairment. The success of mobile communication systems over the last few decades has been mainly due to the adoption of link adaptation that helps to maximise the throughput. In mobile communication systems such as 3G, 4G and 5G, the link-layer is designed with many choices for the forward error correction (FEC) code rates, modulation constellations, waveform type, transmit power levels. These can be jointly selected into sets of transmission parameters. Each set can be thought of as a parametrisation for the generation of the transmitted signal resulting from the joint choices that make the set. A given set is expected to generate a waveform or signal for transmission that is different from what another set would generate. Therefore, a deliberate choice can be made of a particular set of transmission parameters with the expectation that it would generate a transmission signal that is somehow more suitable for a prevailing set of radio channel propagation conditions than another set.

This method of designing link-layers is rather long-winded and laborious because it is difficult to deliberately determine the set of choices for all the configuration parameters. This is firstly, and especially, because the process of choosing between particular communication signal processing techniques such as FEC coding schemes (Low Density Parity Check (LDPC) codes, Turbo codes, or Polar codes, for example) is not trivial. Secondly, this is because even after a particular communication signal processing technique has been chosen, deciding on the set of possible configurations of the chosen technique that have to be designed and standardised is also an onerous process. As an example, if we consider only the FEC, then the radio communication system designer may have to first choose the FEC scheme (LDPC, Turbo or Polar codes etc.), then having chosen the FEC scheme, would need to then decide what block sizes and code rates to support etc. before proceeding to a similar process for modulation constellations etc.

Assuming that the radio-communication system has been designed already, such a system design has already chosen a coding scheme. In addition, it supports a designed number of possible codeword block sizes, a designed number of code rates per block size, a designed number of modulation constellations etc. Link adaptation allows the UE and gNB to work together to determine automatically:
1. The prevailing radio propagation conditions that will affect the transmitted data; and
2. The most appropriate set of link-layer configuration parameters (block size, code rate, modulation constellation etc.) to use so as to maximise throughput and/or transmission resource utilisation for the transmitted data within target reliability and/or latency under the prevailing radio propagation conditions.

This choice of an appropriate set of link-layer configuration parameters is also not trivial as it presents a somewhat multi-dimensional problem with the decision depending for example on the given transmission block size and the prevailing radio propagation channel conditions etc. Link adaptation in 4G and 5G systems is limited to the selection of a configuration from amongst a set of designed choices. For link adaptation of the downlink (DL), the UE measures channel quality parameters on the reception of reference signals transmitted by the BS. The channel quality is then signalled to the BS as a channel quality indicator (CQI) that can be either narrowband or wideband depending on the bandwidth of the reference signals used for its measurement. Based on this CQI report from the UE, the BS can adapt its DL transmissions to maximise throughput. Similarly, for the UL the BS measures channel quality parameters from reception of sounding reference signals (SRS) transmitted by the UE and uses the results of these measurements to instruct the UE how to adapt UL transmissions to maximise throughput. In 4G and 5G systems, since the FEC type for data channels is fixed, link adaptation therefore only involves the selection from a set of possible FEC code rates and modulation constellations—i.e. the modulation and coding scheme (MCS). Transmit power can also be thought of as an aspect of link adaptation, but is not typically adjusted per transmission block.

### Legacy Scheduling Methods in NR (5G)

In cellular wireless communications, the channel between a mobile terminal and the base-station experiences typically rapid and significant variations which impacts the quality of the received signal. In the small-scale variation, the channel goes through frequency selective fading which results in rapid and random variations in the channel attenuation. In the large-scale variation, there are shadowing and distance related pathloss which affect the average received signal strength. In addition, there is interference arising from transmissions from nearby cells and terminals which distorts the signal at the receiver side.

In practice, the heart of mitigating and exploiting the variations of the channel condition is the scheduling mechanism that implements link adaptation algorithms, such as adaptive modulation and coding schemes (AMCS), dynamic power control and channel-dependent scheduling.

In NR, the downlink and uplink multi-user schedulers are located at the base-station (gNB) where, in principle, the scheduler assigns the resources for the users with the best channel conditions in a given instance in both the UL and DL while taking into account the fairness among users as well. There are two types of scheduling mechanism, and these are termed as dynamic scheduling (or dynamic grant) and semi-persistent scheduling (or configured grant).

In dynamic multi-user scheduling for downlink transmissions, based on the instantaneous channel condition where the terminal feeds back the channel quality indicator (CQI) derived from downlink reference signals (RS) at regular time-intervals to the gNB, the scheduler at the gNB, after receiving the CQI, decides the best modulation and coding scheme (MCS), best “available” frequency resources (physical resource blocks (PRBs)) and adequate power for the downlink data transmissions for some users at a given subframe/slot. The downlink scheduling decisions, which are known as scheduling assignments, are carried by downlink control information (DCI), which is transmitted in the downlink to the scheduled users.

Similarly, for the dynamic multi-user scheduling for uplink transmission, based on the instantaneous channel condition where the terminal sends channel SRS at regular time-intervals to the gNB, the scheduler at the gNB, after deriving the CQI based on the last received SRS, decides the best modulation and coding scheme, best frequency resources (PRBs) for the uplink data transmissions from some users at a given subframe/slot. The uplink scheduling decisions, which are also known as scheduling assignments, are carried by downlink control information (DCI) which is transmitted in the downlink to the scheduled users.

For semi-persistent scheduling (SPS) however, the resources are pre-configured semi-statically (e.g. via radio resource control (RRC) signalling) with a certain periodicity, where this periodicity is aligned with the data arrival rate for a particular service. There is an SPS for the downlink (known as DL SPS) and an SPS for the uplink (referred to as configured grant (CG)).

CG resources are mainly intended to deliver multiple traffic classes in a timely manner from the terminal, where such traffic classes have small data rates and some kind of periodicity, as specified in URLLC/IIoT in NR Rel-16/17. Some examples of the different traffic classes include industrial automation (future factory), energy power distribution, and intelligent transport systems, voice.

Issues with Legacy Scheduling Methods

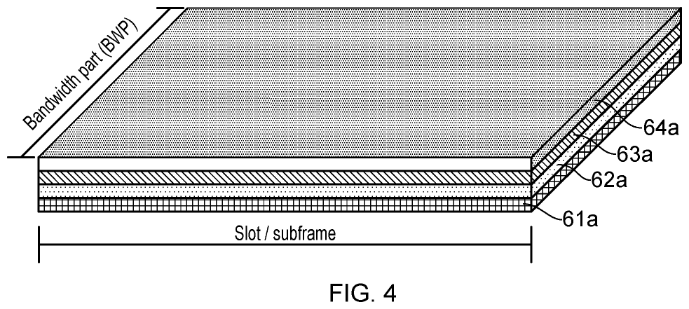

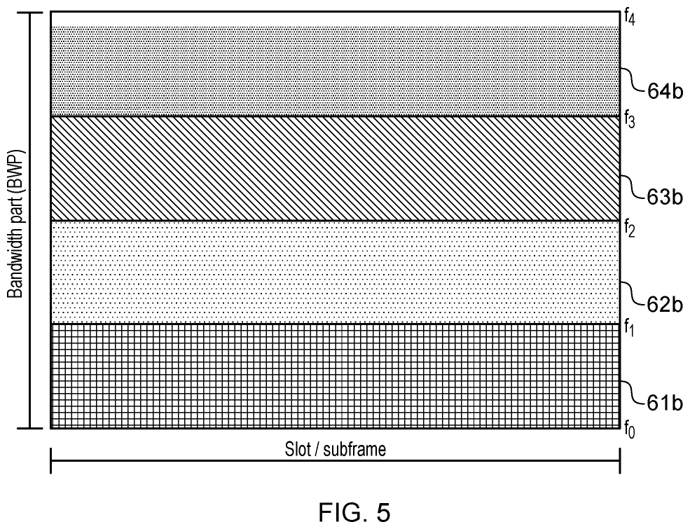

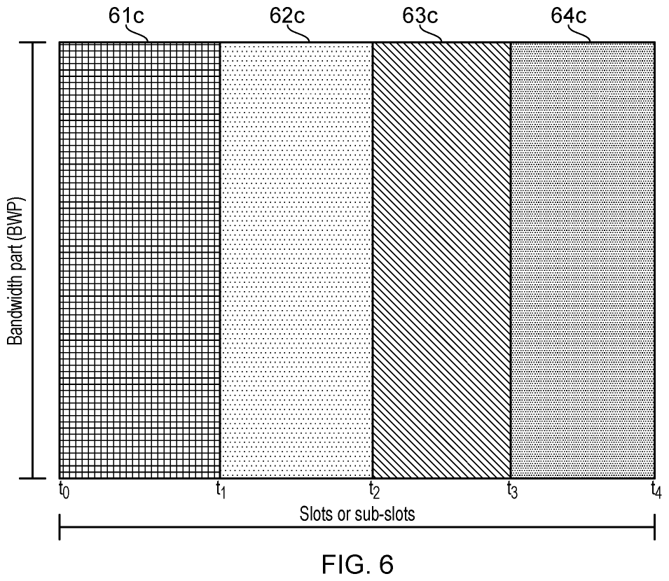

As described above, CG resources are mainly intended for traffic with a low data rate and with some kind of periodicity, as specified in URLLC/IIoT in NR Rel-16/17. However, for traffic with a high data rate and which requires low latency, larger resources would be needed. In this case, a UE can be pre-configured with dedicated larger resources for such uplink data transmissions. These resources can be allocated by one of the following methods (or by a combination of these methods):
Spatial-domain allocation: In this method, the gNB pre-allocates a specific spatial layer to the UE, where different UEs are allocated to different spatial layers in a bandwidth part (BWP), similar to multi-user multiple-input and multiple-output (MU-MIMO). This means that a UE has pre-allocated resources in the spatial-domain for both control and data. Hence, when the UE has data to transmit, the UE uses resources in the spatial layer reserved for it. The spatial-domain resource can be configured for a full set or a sub-set of BWP resources. As shown in the example in FIG. 4, a first UE may be assigned a first spatial layer 61a, a second UE may be assigned a second spatial layer 62a, a third UE may be assigned a third spatial layer 63a, and a fourth UE may be assigned a fourth spatial layer 64a;
Frequency-domain allocation: Similarly, to spatial-domain resources, dedicated frequency-domain resources can be pre-assigned to the UE where different UEs are allocated different frequency resources in a system bandwidth or a BWP. Hence, when data arrives at the UE's buffer, the UE uses the frequency resources allocated for it. As shown in the example in FIG. 5, a first UE may be assigned a first frequency resource set 61b (i.e. frequency range f₀-f₁), a second UE may assigned a second frequency resource set 62b (i.e. frequency range f₁-f₂), a third UE may assigned a third frequency resource set 63b (i.e. frequency range f₂-f₃), and a fourth UE may assigned a fourth frequency resource set 64b (i.e. frequency range f₃-f₄); and
Time-domain allocation: Similarly, to both spatial and frequency-domain resources, dedicated time-domain resources can be pre-allocated for a UE where different UEs are allocated different time resources (e.g. different sub-slots or slots) in a component carrier or BWP. As shown in the example in FIG. 6, a first UE may be assigned a first time resource set 61c (i.e. time range t₀-t₁), a second UE2 may be assigned a second time resource set 62c (i.e. time range t₁-t₂), a third UE may be assigned a third time resource set 63c (i.e. time range t₂-t₃), and a fourth UE may be assigned a fourth time resource set 64c (i.e. time range t₃-t₄).

An issue with using pre-configured dedicated resources for uplink data transmissions is that the resources are always reserved in advance, regardless of whether a UE actually has data to transmit or not. Even though a UE is able to release these pre-configured resources after finishing its UL data transmissions, the concern is that the signalling and commands for re-allocating/re-activating the resources will come from the network, which may result in some unbearable delays for a variety of services like Heavy uplink URLLC, and will also involve signaling from the UE to request resources either via a scheduling request (SR), or initiating a RACH procedure, or will involve resources being configured for idle periods.

Another issue with pre-configured resources is that a UE may not be able to control completely the link adaptation parameters, such as frequency-domain scheduling, in order to choose the best frequency resources (PRBs) in a BWP, modulation and coding scheme (MCS), etc. Since the UE has to wait, after sending its measurements and/or SRS to the network, for the network to determine such link adaptation parameters and signal these to the UE, which both introduces latency and means that the most appropriate parameters may not be selected as the channel conditions may have changed between the time that the UE performed the measurements and/or transmitted the SRS and the time that the UE receives the link adaptation parameters from the gNB.

Another issue with pre-configured resources is that a UE may have to use all the resources whenever it has data to transmit, because the gNB and UE must be synchronised for the allocated resources. This may mean that a UE must add padding bits in order to fill the remaining resources. This is clearly not desirable, as it increases the UE's power consumption unnecessarily, and also generates interference for other UEs located in the same cell or in neighboring cells.

Accordingly, some enhancements for UL scheduling will be required for future mobile communications networks, such as 5G-Advanced and 6G. A set of requirements for such enhanced UL scheduling can be envisioned as listed below:
Immediate transmission of the UL data in order to reduce latency, for example for applications requiring heavy UL data with low latency;
Choosing appropriate link adaptation parameters, for example the best frequency resources (PRBs), MCS, power, etc.;
Flexible resource allocation scheme, for example frequency domain resource allocation (FDRA) and/or time domain resource allocation (TDRA);
An efficient way of identifying a UE and its resource allocation dynamically at the gNB receiver; and
Improving spectral efficiency of the cell, so that when a UE is not using its allocated resources, another UE could in principle be assigned such resources.

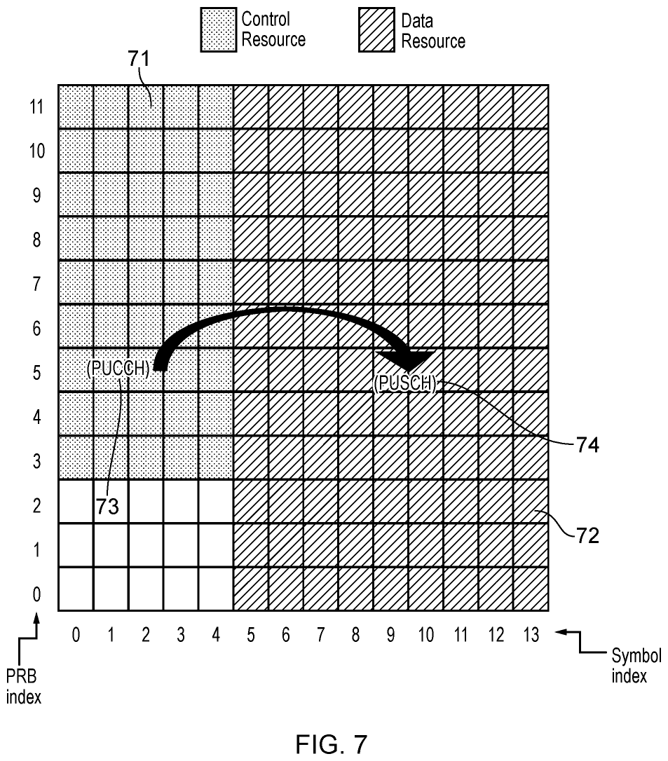

A solution to support UE-based scheduling in accordance with such requirements, where a UE is pre-assigned dedicated uplink resources for UL control and data transmissions in which these resources comprise UE-specific control resources and associated data resources, is provided in [5]. FIG. 7 illustrates an example of such separate control resources 71 and data resources 72 within pre-assigned dedicated resources for a UE, in accordance with what is described in [5].

Here, the UE takes control of its own scheduling decisions (or assignments) for its UL data transmissions, which are to be confined within the pre-assigned dedicated resources. The UE-specific control resource 71 is always available for scheduling the UL data on a specific BWP. Hence, this solution addresses the requirements captured above, including ensuring immediate UL data transmission, provision of appropriate link adaptation and a flexible resource allocation scheme, providing an efficient way of identifying the UE, and improving the spectral efficiency of the cell. In FIG. 7, as is described in [5], If the gNB decodes the PUCCH 73 received within the control resources 71, but not the PUSCH 74 received within the data resources 72, the gNB will send a negative acknowledgement (NACK) to the UE. Otherwise, the gNB will transmit a positive acknowledgement (ACK) to the UE indicating the successful decoding of the PUSCH.

### Bandwidth Parts (BWPs)

A communications device and an infrastructure equipment, such as the communications device 4 and infrastructure equipment 1 of FIG. 1 or the communications device 14 and infrastructure equipment (TRP) 10 of FIG. 2, are configured to communicate via a wireless access interface. The wireless access interface may comprise one or more carriers, each providing, within a range of carrier frequencies, communications resources for transmitting and receiving signals according to a configuration of the wireless access interface. The one or more carriers may be configured within a system bandwidth provided for the wireless communications network of which the infrastructure equipment 1, 10 forms part. Each of the carriers may be divided in a frequency division duplex scheme into an uplink portion and a downlink portion and may comprise one or more bandwidth parts (BWPs). A carrier may be configured therefore with a plurality of different BWP for a communications device to transmit or receive signals. The nature of the wireless access interface may be different amongst the different BWPs. For example, where the wireless access interface is based on orthogonal frequency division multiplexing, different BWPs may have different sub-carrier spacing, symbol periods and/or cyclic prefix lengths. BWPs may have different bandwidths.

By configuring BWPs appropriately, the infrastructure equipment may provide BWPs which are suited for different types of services. For example, a BWP more suitable for eMBB may have a larger bandwidth in order to support high data rates. A BWP suited for URLLC services may use a higher sub-carrier spacing and shorter slot durations, in order to permit lower latency transmissions. Parameters of the wireless access interface which are applicable to a BWP may be referred to collectively as the numerology of a BWP. Examples of such parameters are sub-carrier spacing, symbol and slot durations and cyclic prefix length.

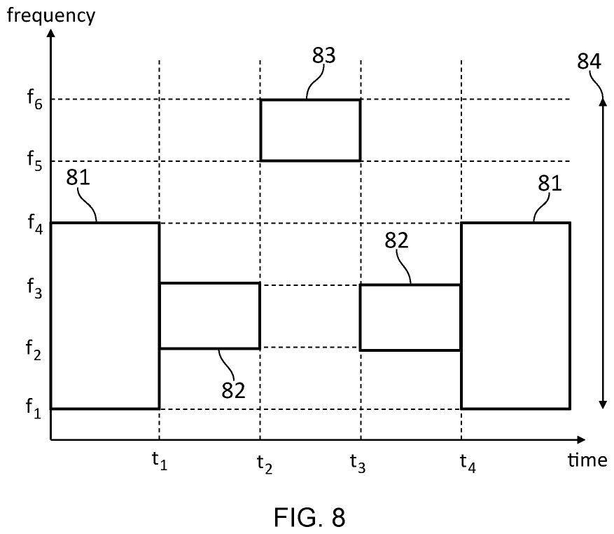

FIG. 8 shows an example of first to third BWPs 81, 82, 83 configured within a system bandwidth 84 extending from frequency f1 to frequency f6. Table 1 below provides a summary of the characteristics of each of the BWPs 81, 82, 83. As shown in Table 1, each BWP may be identified by an index number (bwp-id).

TABLE 1
Summary of BWP characteristics

| BWP | Index (bwp-id) | Frequency range | Sub-carrier spacing |
|---|---|---|---|
| 1101 | 1 | f1-f4 | 15 kHz |
| 1102 | 2 | f2-f3 | 15 kHz |
| 1103 | 3 | f5-f6 | 60 kHz |

In the example in FIG. 8, the BWPs 81, 82, 83 do not collectively span the entire system bandwidth 84. However, in some examples, the frequency range of one or more BWPs collectively spans the system bandwidth 84 (in other words, all frequencies in the system bandwidth may fall within at least one BWP). A frequency range of a BWP may be entirely within the frequency range of another BWP (in this case, the second BWP 82 is within the bandwidth of the first BWP 81).

A BWP may comprise communications resources for uplink or downlink communications. For a communications device, an uplink (UL) BWP and a downlink (DL) BWP may be independently configured, and an association (e.g. pairing) of an UL BWP and a DL BWP may be configured. In some examples, uplink and downlink communications resources are separated in time, in which case time division duplexing (TDD) may be used. In case of TDD, a BWP-pair (UL BWP and DL BWP with the same bwp-id) may have the same centre frequency. In some examples uplink and downlink communications resources are separated in frequency, in which case frequency division duplexing (FDD) may be used. Where FDD is used, a UL BWP and a DL BWP may comprise two non-contiguous frequency ranges, one comprising communications resources for uplink communications and one comprising communications resources for downlink communications. In the remainder of the present disclosure, the term ‘bandwidth part’ (BWP) is used to refer to a pair of associated uplink and downlink bandwidth parts and as such, may comprise communications resources for both uplink and downlink transmissions. The terms ‘uplink bandwidth part’ and ‘downlink bandwidth part’ will be used where appropriate to refer to a bandwidth part comprising only, respectively, uplink communications resources and downlink communications resources.

An activated BWP refers to a BWP which may be used for the transmission or reception of data to or from the communications device 4, 14. An infrastructure equipment 1, 10 may schedule transmissions to or by the communications device 4, 14 only on a BWP if that BWP is currently activated for the communications device 4, 14. On deactivated BWPs, the communications device 4, 14 may not monitor a Physical Downlink Control Channel (PDCCH) and may not transmit on the Physical Uplink Control Channel (PUCCH), the Physical Random Access Channel (PRACH) and the Uplink Shared Channel (UL-SCH).

Conventionally, as illustrated in FIG. 8, at most one BWP providing uplink communications resources and at most one BWP providing downlink communications resources may be activated at any given time in respect of a particular communications device. In the example of FIG. 8, initially (prior to time t1), only the first BWP 81 is activated. At time t1, the first BWP 81 is deactivated and the second BWP 82 is activated. Subsequently, at time t2, the second BWP 82 is deactivated. From t2 to t3, only the third BWP 83 is activated; from t3 to t4 only the second BWP 82 is activated, and at t4, the first BWP 81 is activated and the second BWP 82 is deactivated.

### Initial, First Active and Default BWPs

A BWP may be designated as an initial downlink BWP, which provides the control resource set (CORESET) for downlink information used to schedule downlink transmissions of system information, and a corresponding initial uplink BWP for uplink transmissions for example for initiating PRACH transmission for initial access. When the communications device moves to connected mode, another BWP may be configured and activated as a first active BWP and then used for transmitting control information to or by the communications device 4, 14. The first active BWP can activate another configured BWP(s) if the first active BWP is unsuitable for an ongoing or new service or is insufficient e.g. due to congestion or lack of bandwidth. Alternatively or additionally, a BWP may be designated as a default BWP. If no BWP is explicitly configured as a default BWP, a BWP which is designated as the initial BWP may be the default BWP.

A default BWP may be defined as a BWP that a UE falls back to after an inactivity timer, associated with a BWP other than the default BWP, expires. For example, where a non-default BWP is deactivated as a result of an associated inactivity timer expiring, and no other non-default BWP is activated, then a default BWP may be activated in response. A default BWP may have an activation or deactivation priority which differs from the activation or deactivation priority of other, non-default, BWPs. A default BWP may be preferentially activated and/or may be deactivated with lowest preference. For example, a default BWP may remain activated unless and until a further BWP is to be activated such that a maximum number of activated BWPs would be exceeded. A default BWP may further be preferentially used for transmitting an indication that a different BWP is to be activated or de-activated.

Issues with BWP Switching for UE-Based Scheduling

For the UE-based scheduling mode, if UE currently operating on a wider BWP for transmitting a large data transmission, and then determines that it does not have any further data to transmit for some time, then the BWP inactivity timer (bwp-InactivityTimer) will expire and the UE will switch to a narrower BWP (like the default BWP or initial BWP) in order to reduce the power consumption as described above.

However, while the UE is operating on the narrower BWP, if the UE suddenly notices that some large data is available for transmission, where such data relates to delay-sensitive applications like XR services, the UE may need to activate and switch back to the wider BWP so that it can transmit this data immediately. In this regard, an assumption is being made that UE-based scheduling may only be configured on the wider BWPs (i.e., not on the narrower BWP), because the intention of UE-based scheduling is to transmit large data more efficiently.

In the legacy Rel-15/16/17 specifications, BWP activation and switching may be controlled by the reception of PDCCHs indicating a downlink assignment or an uplink grant for a specific BWP from the network. Alternatively, BWP activation and switching may be controlled by the bwp-InactivityTimer, by RRC signalling, or by the MAC entity upon initiation of a Random Access (RACH) procedure. For TDD (i.e., unpaired spectrum), a DL BWP is paired with an UL BWP with the same index, and BWP switching is common for both UL and DL (or at least, the switching happens at the same time).

It has been recognised by the present inventors that the existing BWP switching/activation methods, for example via PDCCH indication, is very slow. This is because the UE needs first to inform gNB, for example via a scheduling request (SR), that there is a large data available, and then the gNB needs to issue the activation/switching command via a further DCI indication for the UE to switch to the wider BWP. It is assumed that the BWP inactivity timer is not suitable here, as this is only used when there is no activity in the wider BWP, which then causes the UE to switch to narrower BWP, for power saving purposes. In addition, BWP switching controlled by the MAC entity is only used when the UE initiates a RACH procedure.

Accordingly, this embodiments of the present disclosure seek to address and provide solutions to the issue of switching to a wider BWP immediately when the UE is currently operating on a narrower BWP, where the UE is configured with the UE-based scheduling mode and determines that it has a large portion of data to transmit.

### BWP Activation and Switching for UE-Based UL Scheduling and Data Transmission

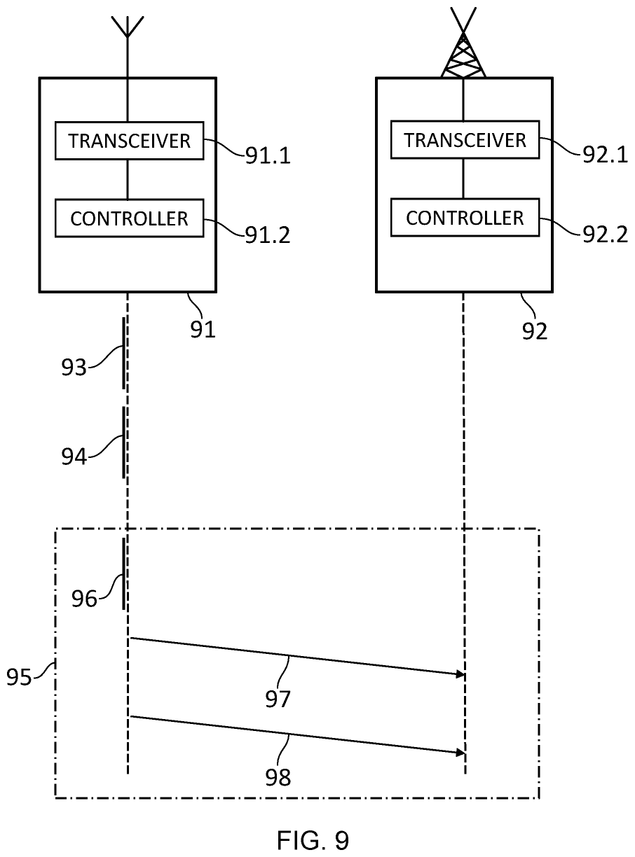

FIG. 9 shows a part schematic, part message flow diagram representation of a first wireless communications system comprising a communications device 91 and an infrastructure equipment 92 in accordance with at least some embodiments of the present technique. The communications device 91 is configured to transmit signals to and/or receive signals from the wireless communications network, for example, to and from the infrastructure equipment 92. Specifically, the communications device 91 may be configured to transmit data to and/or receive data from the wireless communications network (e.g. to/from the infrastructure equipment 92) via a wireless radio interface provided by the wireless communications network (e.g. the Uu interface between the communications device 91 and the Radio Access Network (RAN), which includes the infrastructure equipment 92). The communications device 91 and the infrastructure equipment 92 each comprise a transceiver (or transceiver circuitry) 91.1, 92.1, and a controller (or controller circuitry) 91.2, 92.2. Each of the controllers 91.2, 92.2 may be, for example, a microprocessor, a CPU, or a dedicated chipset, etc.

As shown in the example of FIG. 9, the transceiver circuitry 91.1 and the controller circuitry 91.2 of the communications device 91 are configured in combination to determine 93 that the communications device 91 has uplink data to transmit to the wireless communications network (e.g. to the infrastructure equipment 92), where the uplink data (i.e. the total amount of data in a buffer of the communications device 91) may be equal to or greater than a predetermined size, and to determine 94, independently from the wireless communications network, whether the communications device 91 is to operate in accordance with a communications device based scheduling mode 95 in order to transmit the uplink data, wherein if the communications device 91 determines that it is to operate in accordance with the communications device based scheduling mode 95 in order to transmit the uplink data, the controller circuitry 91.2 is configured in combination with the transceiver circuitry 91.1, as the communications device based scheduling mode 95, to switch 96 from a first bandwidth part, BWP, of the wireless radio interface to a second BWP of the wireless radio interface for transmission of the uplink data, wherein the second BWP has a greater bandwidth than the first BWP and comprises a control resource and a data resource, to transmit 97, to the wireless communications network (e.g. to the infrastructure equipment 92) within the control resource, scheduling information indicating that the communications device 91 is to transmit at least part of the uplink data to the wireless communications network (e.g. to the infrastructure equipment 92), and to transmit 98, to the wireless communications network (e.g. to the infrastructure equipment 92) within the data resource, the at least part of the uplink data in accordance with the transmitted scheduling information. Here, the location of the control resource within the second BWP may be preconfigured and known to both the communications device 91 and the wireless communications network. Furthermore, the transmitted 98 uplink data may be only a part of the total uplink data that the communications device 91 determines 93 it has to transmit to the wireless communications network (e.g. to the infrastructure equipment 92), and the scheduling information transmitted 97 by the communications device 91 to the wireless communications network (e.g. to the infrastructure equipment 92) may therefore relate only to that part of the total uplink data that the communications device 91 transmits 98 to the wireless communications network (e.g. to the infrastructure equipment 92). That is, the total uplink data in the buffer of the communications device 91 may not necessarily, in accordance with embodiments of the present technique, be transmitted 98 as a single transmission, but may be transmitted 98 in accordance with a plurality of separate transmissions in time (scheduled and transmitted separately by the communications device 91 until all of the uplink data that the communications device 91 determines 93 it has to transmit to the wireless communications network (e.g. to the infrastructure equipment 92) has been transmitted 98).

Essentially, embodiments of the present technique propose that a UE is able to autonomously activate and switch to a wider BWP in order to employ UE-based scheduling mode techniques—i.e. where the UE schedules itself on the resources of the wider BWP. In this case, the UE transmits scheduling control information (e.g., carried by PUCCH) and the associated data (e.g., carried by PUSCH) on the wider BWP. The gNB monitors the control resources in every occasion, and checks whether the UE has transmitted the control information (e.g., PUCCH) and, accordingly, the associated data on the wider BWP.

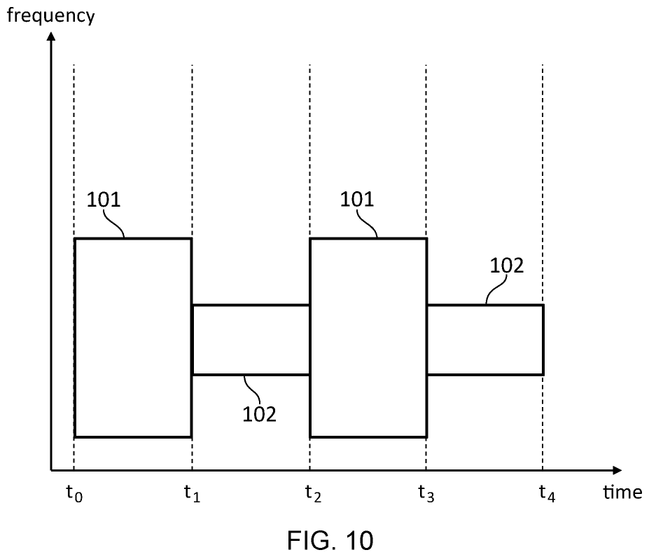

FIG. 10 illustrates an example of bandwidth adaptation comprising wider and narrower bandwidth parts, in accordance with embodiments of the present technique. As shown in FIG. 10, a UE may be configured with two BWPs where BWP1 101 is much wider than BWP2 102 (i.e., BWP1 101>>BWP2 102). For example, BWP2 102 and BWP1 101 may have bandwidth sizes of 10 MHz and 40 MHz respectively, with the same subcarrier spacing of 15 KHz. The example of FIG. 10 assumes that a DL BWP is paired with an UL BWP with the same index, and the switching happens at the same time as in TDD case. The narrower BWP2 102 could be, for example, the default BWP or the initial BWP, based on NR specifications.

At time t₀ to time t₁, the UE is in the wider BWP 101 (for both DL and UL) as it has a large portion of data to transmit, and as such applies the UE-based scheduling mode in the uplink. In this period the UE behaves as shown in, for example, FIGS. 8 and 9 (for example as is described in [5]) where it schedules itself by transmitting scheduling control information and then associated data within control and data resources respectively of the wider BWP 101. After some time, the UE does not have any data to transmit, and so an inactivity timer (e.g. bwp-InactivityTimer) expires, therefore the UE falls back to narrower BWP2 102 in order to reduce power consumption. The UE is in the narrower BWP2 102 during the period from time t₁ to time t₂. In other words, the communications device may be configured to determine that a specified period has elapsed after transmitting the uplink data to the wireless communications network, and to switch, in response to determining that the specified period has elapsed, from the second BWP to the first BWP.

Suddenly, the UE notices that a large portion of data is available for transmission, where this data relates to a delay sensitive application such as to XR services, and so the UE needs to switch to the wider BWP1 101 again in order to transmit this data. In this case, between time t₂ and time t₃, the UE activates and switches to the wider BWP 101 autonomously and then schedules itself on the resources on the wider BWP 101 by employing the UE-based scheduling procedure. As the gNB has been constantly monitoring the control resources of the wider BWP 101, it will detect the control information (e.g., PUCCH) which indicates the scheduling information of the UE, and then will be able to successfully receive the associated data (which is carried, for example, by a PUSCH). The UE may then continue to schedule itself as long as it has data to transmit in the subsequent time slots.

Further, at time t₃ (until, for example, time t₄), the UE does not have any data to transmit and so the inactivity timer (e.g. bwp-InactivityTimer) again expires. Accordingly, the UE falls back to the narrower BWP2 102 in order to reduce power consumption. Here, as shown in the example of FIG. 10, the switching from the first BWP 101 to the second BWP 102 and the switching from the second BWP 102 to the first BWP 101 are performed periodically by the communications device.

It should be noted here that—in accordance with embodiments of the present disclosure—when a UE activates a BWP and switches from a current BWP to that newly activated BWP, it also deactivates the current BWP. This is the legacy behaviour from Rel-15 onward. Further detail with respect to the actions of BWP activation and deactivation may be found in, for example, [6]. In other words, in accordance with embodiments of the present disclosure, as the skilled person would appreciate, when switching between two BWPs, the communications device may be configured to deactivate the BWP being switched from and to activate the BWP being switched to.

Furthermore, it should be noted that UEs which are able to autonomously switch to a wider BWP and schedule and transmit uplink data in accordance with the UE-based scheduling mode may be a certain class(es) of UEs, or UEs which are configured to transmit data in accordance with certain applications or services (for example XR or heavy uplink URLLC). Such UEs (or any other subset of UEs) may be configured by the network to allow them to operate in accordance with such autonomous switching and UE-based scheduling behaviour, or to stop operating in such a manner.

The only drawback of the method illustrated by FIGS. 8 and 9 and described above with respect to these figures is that the gNB is required to monitor the scheduling control information from the UE all the time, even when the UE is not actually on the wider BWP, because the gNB does not know exactly when the UE will autonomously switch to the wider BWP. However, it is not anticipated that this will be an issue, as the gNB is more powerful in terms of processing power than the UE, and is also mostly connected to the mains/power supply. That is, a trade off in respect of reducing power consumption and increasing efficiency at a UE at the expense of the opposite at the gNB is generally advantageous.

In some arrangements of embodiments of the present technique, after a UE activates and switches to the narrower BWP, the UE does not apply the UE-based scheduling mode. The motivation is that the UE can only transmit small portions of data, for example configured grant (CG) data, where the CG resources may be configured to be periodic based on the traffic profile of the CG data. In other words, the communications device may be configured, while operating on the first BWP, to determine that the communications device has second uplink data to transmit to the wireless communications network (where the second uplink data may be smaller than the predetermined size), and to transmit, to the wireless communications network, the second uplink data within configured grant, CG, resources of the first BWP. Here, the CG resources may be one instance of a sequence of periodically occurring instances of uplink communications resources of the first BWP. In response to transmitting the small CG (i.e. second) data, the communications device may be configured to receive, from the wireless communications network, an indication that the communications device is to switch from the first BWP to the second BWP and is to transmit any further uplink data within the second BWP in accordance with the communications device based scheduling mode.

In some arrangements of embodiments of the present technique, after a UE activates and switches to the narrower BWP, the UE may inform the network about the availability of any subsequent large data in its buffer via, for example, a scheduling request (SR), since the UE is not at this time applying the UE-based scheduling mode. Upon receiving the SR, the network is able to configure the UE to activate and switch to the wider BWP, and instruct the UE to transmit UL data in accordance with the UE-based scheduling procedure in the subsequent time slots. In other words, the communications device may be configured, after switching from the second BWP to the first BWP, to determine that the communications device has second uplink data to transmit to the wireless communications network (where the second uplink data may be equal to or greater than the predetermined size), to transmit, to the wireless communications network in response to determining that the communications device has the second uplink data to transmit to the wireless communications network, a scheduling request, and to receive, from the wireless communications network in response to the transmitted scheduling request, an indication that the communications device is to switch from the first BWP to the second BWP and is to transmit the second uplink data within the second BWP in accordance with the communications device based scheduling mode.

In some arrangements of embodiments of the present technique, after a UE activates and switches to the narrower BWP, the UE starts a new timer. If this timer expires, the UE switches to the larger BWP. In other words, the communications device may be configured to determine that a second specified period has elapsed after switching from the second BWP to the first BWP, and to switch, in response to determining that the second specified period has elapsed, from the first BWP to the second BWP. This new timer may be aligned with the arrival of data (i.e. a new large amount of UL data) on the wider BWP. In other words, the second specified period is a period between the communications device switching from the second BWP to the first BWP and the communications device having second uplink data to transmit to the wireless communications network (where the second uplink data may be equal to or greater than the predetermined size). Here, both of the uplink data and the second uplink data may be instances of periodic uplink data, where one or more of these instances of periodic uplink data may be equal to or greater than the predetermined size.

In some arrangements of embodiments of the present technique, a UE (which, like UEs/communications devices described herein in accordance with embodiments of the present technique generally, has been configured in advance by the network to be able to operate in accordance with the UE-based scheduling mode) may change its strategy of uplink BWP activation/switching depending on power class of the UE, and or transmission power headroom (PHR) available to the UE, and/or on a UE's position within the cell (which may be detected, for example, based on a level of pathloss between the UE and gNB). In other words, the communications device may be configured to determine whether the communications device is to operate in accordance with the communications device based scheduling mode in order to transmit the uplink data is based on one or more of: a power class of the communications device, a capability of the communications device, a power headroom of the communications device, and a level of pathloss between the communications device and the wireless communications network.

The downlink power is shared among different users, and the gNB is able to re-allocate the power to other UEs. When a downlink bandwidth part is expanded, the gNB can allocate more power for it. On the other hand, uplink power cannot exceed the UE's own maximum power (max power capability is defined by the UE's Power class). So, when the UE is located at the cell edge, the room of remaining Tx power (i.e. power headroom (PHR)) is limited. A UE cannot generally easily expand the uplink bandwidth part (i.e. switch from a narrower BWP to a wider BWP) at the cell edge, unless the UE is a high power class UE. The UE's power class is defined in that UE's capability. For example, in frequency range 2 (FR2) (i.e. mmWave), power class 1 is 35 dBm for high throughput UEs like fixed wireless access UEs, while others are 23 dBm. In frequency range 1 (FR1) (i.e. 410 MHz to 7125 MHz), power class 2 is a maximum of 26 dBm, and power class 3 is 23 dBm. Further power classes may be newly defined and added in the future for different types of UEs/applications. By contrast, a UE that is located more closely to the cell center can dynamically expand the bandwidth part (i.e. switch from a narrower BWP to a wider BWP) because the UE has still more power headroom.

In the former case, where the UE is unable to switch to a wider BWP, the UE may indicate such a status to the gNB, where this indication may be conveyed via uplink control information (UCI). In other words, the communications device may be configured to determine that the communications device is not to operate in accordance with the communications device based scheduling mode in order to transmit the uplink data. Here, the communications device may be configured to transmit, to the wireless communications network, an indication that the communications device is not to operate in accordance with the communications device based scheduling mode in order to transmit the uplink data. Then, the gNB will be aware that the UE cannot change the uplink bandwidth part (e.g. based on limited PHR available to that UE). Based on the indication, gNB may change the UL scheduling strategy to a time domain solution rather than a frequency domain solution (i.e. switching bandwidth part). For example, the strategy may be changed to one which employs repetition of time resources, or instructing the UE to fall back to gNB-based scheduling. An example of such a scheduling strategy is that the gNB may use a low order modulation scheme (e.g. QPSK) rather than a higher order modulation scheme (e.g. 64 QAM), and/or may select a lower coding rate (i.e. utilising more parity bits for error correction). This may mitigate losses in peak transmission power, though instead has a downside of requiring more time resources for transmitting the same amount of data. In other words, the communications device may be configured to receive, from the wireless communications network, an indication that the communications device is to operate in accordance with a second communications device based scheduling mode in order to transmit the uplink data, and the method comprises, as the second communications device based scheduling mode, to transmit, to the wireless communications network within a control resource of the first BWP, scheduling information indicating that the communications device is to transmit the uplink data to the wireless communications network, and to transmit, to the wireless communications network within a data resource of the first BWP, the uplink data in accordance with the transmitted scheduling information, wherein the data resource of the first BWP has a smaller bandwidth than the data resource of the second BWP, and wherein the transmitting the uplink data within the data resource of the first BWP comprises transmitting the uplink data over a longer time period than if the uplink data was transmitted within the data resource of the second BWP. Alternatively (or in addition), the communications device may be configured to receive, from the wireless communications network, an uplink grant indicating resources within the first BWP in which the communications device is to transmit the uplink data, and to transmit, to the wireless communications network, the uplink data in the resources within the first BWP indicated by the uplink grant.

Alternatively, instead of receiving such an indication (e.g. via UCI), the gNB may use other information indirectly (i.e. by detecting or knowing such information itself) such as the UE's transmission power headroom (PHR), the level of pathloss between the UE and the gNB, the UE's power class, etc., in order to change the UL scheduling strategy. In other words, the infrastructure equipment may be configured to determine that the communications device will independently determine that it is not to operate in accordance with the communications device based scheduling mode in order to transmit the uplink data, wherein the determining that the communications device will independently determine that it is not to operate in accordance with the communications device based scheduling mode in order to transmit the uplink data is based on one or more of: a power class of the communications device, a capability of the communications device, a power headroom of the communications device, and a level of pathloss between the communications device and the wireless communications network.

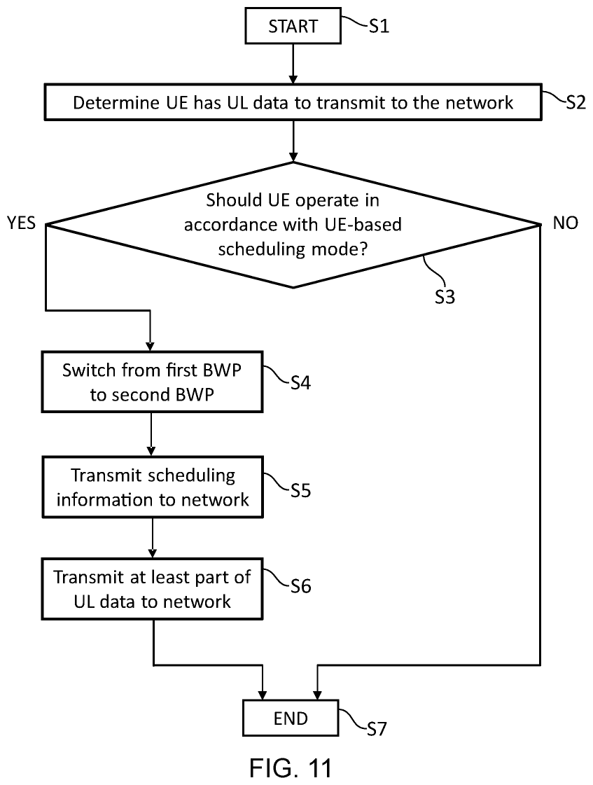

FIG. 11 shows a flow diagram illustrating an example process of communications in a communications system in accordance with embodiments of the present technique. The process shown by FIG. 11 is a method of operating a communications device configured to transmit signals to and/or to receive signals from a wireless communications network (e.g. to or from an infrastructure equipment of the wireless communications network), the communications device operating in a connected mode with the wireless communications network.

The method begins in step S1. The method comprises, in step S2, determining that the communications device has uplink data to transmit to the wireless communications network. In step S3, the process comprises determining, whether the communications device is to operate in accordance with a communications device based scheduling mode in order to transmit the uplink data. Then, in step S4, if the communications device determines in step S3 that it is to operate in accordance with the communications device based scheduling mode in order to transmit the uplink data, the process comprises, as a first step of the communications device based scheduling mode, switching from a first bandwidth part, BWP, of the wireless radio interface to a second BWP of the wireless radio interface for transmission of the uplink data, wherein the second BWP has a greater bandwidth than the first BWP and comprises a control resource and a data resource. In step S5, the method comprises, as a second step of the communications device based scheduling mode, transmitting, to the wireless communications network within the control resource, scheduling information indicating that the communications device is to transmit at least part of the uplink data to the wireless communications network. Then, in step S6, the process comprises, as a third step of the communications device based scheduling mode, transmitting, to the wireless communications network within the data resource, the at least part of the uplink data in accordance with the transmitted scheduling information. The process ends in step S7.

However, if in step S4 the communications device determines that it is not to operate in accordance with the communications device based scheduling mode in order to transmit the uplink data, the process (in accordance with the example process of communications in a communications system in accordance with embodiments of the present technique illustrated by FIG. 11) simply ends in step S7. Those skilled in the art would of course understand that here, as described above, the communications device may instead transmit the uplink data in accordance with other behaviour, for example, by falling back to gNB-based scheduling by requesting and receiving resource allocations from the infrastructure equipment, or by receiving an indication from the infrastructure equipment that it should operate in accordance with a second (modified) communications device based scheduling mode in which the strategy of resource allocation by the communications device is changed from the frequency domain to the time domain, for example by employing time-domain repetition techniques.

Those skilled in the art would appreciate that the method shown by FIG. 11 may be adapted in accordance with embodiments of the present technique. For example, other intermediate steps may be included in this method, or the steps may be performed in any logical order. Though embodiments of the present technique have been described largely by way of the example communications system shown in FIG. 9, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device configured to transmit signals to and/or to receive signals from a wireless communications network via a wireless radio interface provided by the wireless communications network, the method comprising
determining that the communications device has uplink data to transmit to the wireless communications network, and
determining, independently from the wireless communications network, whether the communications device is to operate in accordance with a communications device based scheduling mode in order to transmit the uplink data, wherein if the communications device determines that it is to operate in accordance with the communications device based scheduling mode in order to transmit the uplink data, the method comprises, as the communications device based scheduling mode,
switching from a first bandwidth part, BWP, of the wireless radio interface to a second BWP of the wireless radio interface for transmission of the uplink data, wherein the second BWP has a greater bandwidth than the first BWP and comprises a control resource and a data resource,
transmitting, to the wireless communications network within the control resource, scheduling information indicating that the communications device is to transmit at least part of the uplink data to the wireless communications network, and
transmitting, to the wireless communications network within the data resource, the at least part of the uplink data in accordance with the transmitted scheduling information.

Paragraph 2. A method according to Paragraph 1, wherein the location of the control resource within the second BWP is preconfigured and known to both the communications device and the wireless communications network.

Paragraph 3. A method according to Paragraph 1 or Paragraph 2, comprising
determining that a specified period has elapsed after transmitting the uplink data to the wireless communications network, and
switching, in response to determining that the specified period has elapsed, from the second BWP to the first BWP.

Paragraph 4. A method according to Paragraph 3, comprising, after switching from the second BWP to the first BWP,
determining that the communications device has second uplink data to transmit to the wireless communications network,
transmitting, to the wireless communications network in response to determining that the communications device has the second uplink data to transmit to the wireless communications network, a scheduling request, and
receiving, from the wireless communications network in response to the transmitted scheduling request, an indication that the communications device is to switch from the first BWP to the second BWP and is to transmit the second uplink data within the second BWP in accordance with the communications device based scheduling mode.

Paragraph 5. A method according to Paragraph 3 or Paragraph 4, comprising
determining that a second specified period has elapsed after switching from the second BWP to the first BWP, and
switching, in response to determining that the second specified period has elapsed, from the first BWP to the second BWP.

Paragraph 6. A method according to Paragraph 5, wherein the second specified period is a period between the communications device switching from the second BWP to the first BWP and the communications device having second uplink data to transmit to the wireless communications network.

Paragraph 7. A method according to Paragraph 6, wherein both of the uplink data and the second uplink data are instances of periodic uplink data.

Paragraph 8. A method according to any of Paragraphs 3 to 7, wherein the switching from the first BWP to the second BWP and the switching from the second BWP to the first BWP are performed periodically by the communications device.

Paragraph 9. A method according to any of Paragraphs 1 to 8, comprising, while operating on the first BWP,
determining that the communications device has second uplink data to transmit to the wireless communications network, and
transmitting, to the wireless communications network, the second uplink data within configured grant, CG, resources of the first BWP.

Paragraph 10. A method according to Paragraph 9, wherein the CG resources are one instance of a sequence of periodically occurring instances of uplink communications resources of the first BWP.

Paragraph 11. A method according to Paragraph 9 or Paragraph 10, comprising
receiving, from the wireless communications network in response to the transmitted second uplink data, an indication that the communications device is to switch from the first BWP to the second BWP and is to transmit any further uplink data within the second BWP in accordance with the communications device based scheduling mode.

Paragraph 12. A method according to any of Paragraphs 1 to 11, wherein the determining whether the communications device is to operate in accordance with the communications device based scheduling mode in order to transmit the uplink data is based on one or more of:
a power class of the communications device,
a capability of the communications device,
a power headroom of the communications device, and
a level of pathloss between the communications device and the wireless communications network.

Paragraph 13. A method according to Paragraph 12, comprising
determining that the communications device is not to operate in accordance with the communications device based scheduling mode in order to transmit the uplink data.

Paragraph 14. A method according to Paragraph 13, comprising
transmitting, to the wireless communications network, an indication that the communications device is not to operate in accordance with the communications device based scheduling mode in order to transmit the uplink data.

Paragraph 15. A method according to Paragraph 13 or Paragraph 14, comprising
receiving, from the wireless communications network, an indication that the communications device is to operate in accordance with a second communications device based scheduling mode in order to transmit the uplink data, and the method comprises, as the second communications device based scheduling mode,
transmitting, to the wireless communications network within a control resource of the first BWP, scheduling information indicating that the communications device is to transmit the uplink data to the wireless communications network, and
transmitting, to the wireless communications network within a data resource of the first BWP, the uplink data in accordance with the transmitted scheduling information, wherein the data resource of the first BWP has a smaller bandwidth than the data resource of the second BWP, and wherein the transmitting the uplink data within the data resource of the first BWP comprises transmitting the uplink data over a longer time period than if the uplink data was transmitted within the data resource of the second BWP.

Paragraph 16. A method according to any of Paragraphs 13 to 15, comprising
receiving, from the wireless communications network, an uplink grant indicating resources within the first BWP in which the communications device is to transmit the uplink data, and
transmitting, to the wireless communications network, the uplink data in the resources within the first BWP indicated by the uplink grant.

Paragraph 17. A method according to any of Paragraphs 1 to 16, comprising, when switching between two BWPs,
deactivating the BWP being switched from and activating the BWP being switched to.

Paragraph 18. A method according to any of Paragraphs 1 to 17, wherein the first BWP is a default BWP.

Paragraph 19. A method according to any of Paragraphs 1 to 18, wherein the first BWP is an initial BWP.

Paragraph 20. A method according to any of Paragraphs 1 to 19, wherein the scheduling information is transmitted within a Physical Uplink Control Channel, PUCCH.

Paragraph 21. A method according to any of Paragraphs 1 to 20, wherein the uplink data is transmitted within a Physical Uplink Shared Channel, PUSCH.

Paragraph 22. A method according to any of Paragraphs 1 to 21, wherein the uplink data is equal to or greater than a predetermined size.

Paragraph 23. A method according to any of Paragraphs 1 to 22, wherein the uplink data that the communications device determines it has to transmit to the wireless communications network is the total amount of uplink data available for transmission in a buffer of the communications device.

Paragraph 24. A communications device comprising
transceiver circuitry configured to transmit signals to and/or to receive signals from a wireless communications network via a wireless radio interface provided by the wireless communications network, and
controller circuitry configured in combination with the transceiver circuitry
to determine that the communications device has uplink data to transmit to the wireless communications network, and
to determine, independently from the wireless communications network, whether the communications device is to operate in accordance with a communications device based scheduling mode in order to transmit the uplink data, wherein if the communications device determines that it is to operate in accordance with the communications device based scheduling mode in order to transmit the uplink data, the controller circuitry is configured in combination with the transceiver circuitry, as the communications device based scheduling mode,
to switch from a first bandwidth part, BWP, of the wireless radio interface to a second BWP of the wireless radio interface for transmission of the uplink data, wherein the second BWP has a greater bandwidth than the first BWP and comprises a control resource and a data resource,
to transmit, to the wireless communications network within the control resource, scheduling information indicating that the communications device is to transmit at least part of the uplink data to the wireless communications network, and
to transmit, to the wireless communications network within the data resource, the at least part of the uplink data in accordance with the transmitted scheduling information.

Paragraph 25. Circuitry for a communications device comprising
transceiver circuitry configured to transmit signals to and/or to receive signals from a wireless communications network via a wireless radio interface provided by the wireless communications network, and
controller circuitry configured in combination with the transceiver circuitry
to determine that the transceiver circuitry has uplink data to transmit to the wireless communications network, and
to determine, independently from the wireless communications network, whether the circuitry is to operate in accordance with a communications device based scheduling mode in order to transmit the uplink data, wherein if the circuitry determines that it is to operate in accordance with the communications device based scheduling mode in order to transmit the uplink data, the controller circuitry is configured in combination with the transceiver circuitry, as the communications device based scheduling mode,
to switch from a first bandwidth part, BWP, of the wireless radio interface to a second BWP of the wireless radio interface for transmission of the uplink data, wherein the second BWP has a greater bandwidth than the first BWP and comprises a control resource and a data resource,
to transmit, to the wireless communications network within the control resource, scheduling information indicating that the transceiver circuitry is to transmit at least part of the uplink data to the wireless communications network, and
to transmit, to the wireless communications network within the data resource, the at least part of the uplink data in accordance with the transmitted scheduling information.

Paragraph 26. A method of operating an infrastructure equipment forming part of a wireless communications network, the infrastructure equipment being configured to transmit signals to and/or to receive signals from a communications device via a wireless radio interface provided by the infrastructure equipment, the method comprising
determining that the communications device, which is currently operating on a first bandwidth part, BWP, of the wireless radio interface, has uplink data to transmit to the infrastructure equipment, and determining that the communications device will independently determine whether it is to operate in accordance with a communications device based scheduling mode in order to transmit the uplink data, wherein if the infrastructure equipment determines that the communications device will independently determine that it is to operate in accordance with the communications device based scheduling mode in order to transmit the uplink data, the method comprises, in accordance with the communications device based scheduling mode,
determining that the communications device will switch from the first BWP of the wireless radio interface to a second BWP of the wireless radio interface for transmission of the uplink data, wherein the second BWP has a greater bandwidth than the first BWP and comprises a control resource and a data resource,
receiving, from the communications device within the control resource, scheduling information indicating that the communications device is to transmit at least part of the uplink data to the infrastructure equipment, and
receiving, from the communications device within the data resource, the at least part of the uplink data in accordance with the received scheduling information.

Paragraph 27. A method according to Paragraph 26, wherein the location of the control resource within the second BWP is preconfigured and known to both the communications device and infrastructure equipment.

Paragraph 28. A method according to Paragraph 26 or Paragraph 27, comprising
determining that a specified period has elapsed after receiving the uplink data from the communications device, and
determining, in response to determining that the specified period has elapsed, that the communications device will switch from the second BWP to the first BWP.

Paragraph 29. A method according to Paragraph 28, comprising, after the communications device has switched from the second BWP to the first BWP,
receiving, from the communications device, a scheduling request indicating that the communications device has second uplink data to transmit to the wireless communications network, and
transmitting, to the communications device in response to the received scheduling request, an indication that the communications device is to switch from the first BWP to the second BWP and is to transmit the second uplink data within the second BWP in accordance with the communications device based scheduling mode.

Paragraph 30. A method according to Paragraph 28 or Paragraph 29, comprising
determining that a second specified period has elapsed after the communications device has switched from the second BWP to the first BWP, and
determining, in response to determining that the second specified period has elapsed, that the communications device will switch from the first BWP to the second BWP.

Paragraph 31. A method according to Paragraph 30, wherein the second specified period is a period between the communications device switching from the second BWP to the first BWP and the communications device having second uplink data to transmit to the wireless communications network.

Paragraph 32. A method according to Paragraph 31, wherein both of the uplink data and the second uplink data are instances of periodic uplink data.

Paragraph 33. A method according to any of Paragraphs 28 to 32, comprising
determining that the switching from the first BWP to the second BWP and the switching from the second BWP to the first BWP are performed periodically by the communications device.

Paragraph 34. A method according to any of Paragraphs 26 to 33, comprising
receiving, from the communications device, second uplink data within configured grant, CG, resources of the first BWP.

Paragraph 35. A method according to Paragraph 34, wherein the CG resources are one instance of a sequence of periodically occurring instances of uplink communications resources of the first BWP.

Paragraph 36. A method according to Paragraph 34 or Paragraph 35, comprising
transmitting, to the communications device in response to the transmitted second uplink data, an indication that the communications device is to switch from the first BWP to the second BWP and is to transmit any further uplink data within the second BWP in accordance with the communications device based scheduling mode.

Paragraph 37. A method according to any of Paragraphs 26 to 36, comprising
determining that the communications device will independently determine that it is not to operate in accordance with the communications device based scheduling mode in order to transmit the uplink data.

Paragraph 38. A method according to Paragraph 37, comprising
receiving, from the communications device, an indication that the communications device is not to operate in accordance with the communications device based scheduling mode in order to transmit the uplink data,
wherein the determining that the communications device will independently determine that it is not to operate in accordance with the communications device based scheduling mode in order to transmit the uplink data is based on the received indication.

Paragraph 39. A method according to Paragraph 37 or Paragraph 38, wherein the determining that the communications device will independently determine that it is not to operate in accordance with the communications device based scheduling mode in order to transmit the uplink data is based on one or more of:
a power class of the communications device,
a capability of the communications device,
a power headroom of the communications device, and
a level of pathloss between the communications device and the wireless communications network.

Paragraph 40. A method according to any of Paragraphs 37 to 39, comprising
transmitting, to the communications device, an indication that the communications device is to operate in accordance with a second communications device based scheduling mode in order to transmit the uplink data, and the method comprises, in accordance with the second communications device based scheduling mode,
receiving, from the communications device within a control resource of the first BWP, scheduling information indicating that the communications device is to transmit the uplink data to the wireless communications network, and
receiving, from the communications device within a data resource of the first BWP, the uplink data in accordance with the received scheduling information, wherein the data resource of the first BWP has a smaller bandwidth than the data resource of the second BWP, and wherein the receiving the uplink data within the data resource of the first BWP comprises receiving the uplink data over a longer time period than if the uplink data was received within the data resource of the second BWP.

Paragraph 41. A method according to any of Paragraphs 37 to 40, comprising
transmitting, to the communications device, an uplink grant indicating resources within the first BWP in which the communications device is to transmit the uplink data, and
receiving, from the communications device, the uplink data in the resources within the first BWP indicated by the uplink grant.

Paragraph 42. A method according to any of Paragraphs 26 to 41, wherein the first BWP is a default BWP.

Paragraph 43. A method according to any of Paragraphs 26 to 42, wherein the first BWP is an initial BWP.

Paragraph 44. A method according to any of Paragraphs 26 to 43, wherein the scheduling information is received within a Physical Uplink Control Channel, PUCCH.

Paragraph 45. A method according to any of Paragraphs 26 to 44, wherein the uplink data is received within a Physical Uplink Shared Channel, PUSCH.

Paragraph 46. A method according to any of Paragraphs 26 to 45, wherein the uplink data is equal to or greater than a predetermined size.

Paragraph 47. A method according to any of Paragraphs 26 to 46, wherein the uplink data that the infrastructure equipment determines the communications device has to transmit to the infrastructure equipment is the total amount of uplink data available for transmission in a buffer of the communications device.

Paragraph 48. An infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to determine that the communications device, which is currently operating on a first bandwidth part, BWP, of the wireless radio interface, has uplink data to transmit to the infrastructure equipment, and
to determine that the communications device will independently determine whether it is to operate in accordance with a communications device based scheduling mode in order to transmit the uplink data, wherein if the infrastructure equipment determines that the communications device will independently determine that it is to operate in accordance with the communications device based scheduling mode in order to transmit the uplink data, the controller circuitry is configured in combination with the transceiver circuitry, in accordance with the communications device based scheduling mode,
to determine that the communications device will switch from the first BWP of the wireless radio interface to a second BWP of the wireless radio interface for transmission of the uplink data, wherein the second BWP has a greater bandwidth than the first BWP and comprises a control resource and a data resource,
to determine, from the communications device within the control resource, scheduling information indicating that the communications device is to transmit at least part of the uplink data to the infrastructure equipment, and
to determine, from the communications device within the data resource, the at least part of the uplink data in accordance with the received scheduling information.

Paragraph 49. Circuitry for an infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to determine that the communications device, which is currently operating on a first bandwidth part, BWP, of the wireless radio interface, has uplink data to transmit to the circuitry, and
to determine that the communications device will independently determine whether it is to operate in accordance with a communications device based scheduling mode in order to transmit the uplink data, wherein if the circuitry determines that the communications device will independently determine that it is to operate in accordance with the communications device based scheduling mode in order to transmit the uplink data, the controller circuitry is configured in combination with the transceiver circuitry, in accordance with the communications device based scheduling mode,
to determine that the communications device will switch from the first BWP of the wireless radio interface to a second BWP of the wireless radio interface for transmission of the uplink data, wherein the second BWP has a greater bandwidth than the first BWP and comprises a control resource and a data resource,
to determine, from the communications device within the control resource, scheduling information indicating that the communications device is to transmit at least part of the uplink data to the transceiver circuitry, and
to determine, from the communications device within the data resource, the at least part of the uplink data in accordance with the received scheduling information.

Paragraph 50. A wireless communications system comprising a communications device according to Paragraph 24 and an infrastructure equipment according to Paragraph 48.

Paragraph 51. A computer program comprising instructions which, when loaded onto a computer, cause the computer to perform a method according to any of Paragraphs 1 to 23 or Paragraphs 26 to 47. Paragraph 52. A non-transitory computer-readable storage medium storing a computer program according to Paragraph 51.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] RP-190726, “Physical layer enhancements for NR ultra-reliable and low latency communication (URLLC)”, Huawei, HiSilicon, RAN #83, March 2019.
[4] RP-201310, “Revised WID: Enhanced Industrial Internet of Things (IoT) and ultra-reliable and low latency communication (URLLC) support for NR,” Nokia, Nokia Shanghai Bell, RAN #88e, July 2020.
[5] European patent application with publication number EP3837895.
[6] TS 38.321, “NR; Medium Access Control (MAC) protocol specification (Release 16)”, 3rd Generation Partnership Project, v16.0.0, March 2020.

1. A method of operating a communications device configured to transmit signals to and/or to receive signals from a wireless communications network via a wireless radio interface provided by the wireless communications network, the method comprising
determining that the communications device has uplink data to transmit to the wireless communications network, and
determining, independently from the wireless communications network, whether the communications device is to operate in accordance with a communications device based scheduling mode in order to transmit the uplink data, wherein if the communications device determines that it is to operate in accordance with the communications device based scheduling mode in order to transmit the uplink data, the method comprises, as the communications device based scheduling mode,
switching from a first bandwidth part, BWP, of the wireless radio interface to a second BWP of the wireless radio interface for transmission of the uplink data, wherein the second BWP has a greater bandwidth than the first BWP and comprises a control resource and a data resource,
transmitting, to the wireless communications network within the control resource, scheduling information indicating that the communications device is to transmit at least part of the uplink data to the wireless communications network, and
transmitting, to the wireless communications network within the data resource, the at least part of the uplink data in accordance with the transmitted scheduling information.

2. A method according to claim 1, wherein the location of the control resource within the second BWP is preconfigured and known to both the communications device and the wireless communications network.

3. A method according to claim 1, comprising
determining that a specified period has elapsed after transmitting the uplink data to the wireless communications network, and
switching, in response to determining that the specified period has elapsed, from the second BWP to the first BWP.

4. A method according to claim 3, comprising, after switching from the second BWP to the first BWP,
determining that the communications device has second uplink data to transmit to the wireless communications network,
transmitting, to the wireless communications network in response to determining that the communications device has the second uplink data to transmit to the wireless communications network, a scheduling request, and
receiving, from the wireless communications network in response to the transmitted scheduling request, an indication that the communications device is to switch from the first BWP to the second BWP and is to transmit the second uplink data within the second BWP in accordance with the communications device based scheduling mode.

5. A method according to claim 3, comprising
determining that a second specified period has elapsed after switching from the second BWP to the first BWP, and
switching, in response to determining that the second specified period has elapsed, from the first BWP to the second BWP.

6. A method according to claim 5, wherein the second specified period is a period between the communications device switching from the second BWP to the first BWP and the communications device having second uplink data to transmit to the wireless communications network.

7. A method according to claim 6, wherein both of the uplink data and the second uplink data are instances of periodic uplink data.

8. A method according to claim 3, wherein the switching from the first BWP to the second BWP and the switching from the second BWP to the first BWP are performed periodically by the communications device.

9. A method according to claim 1, comprising, while operating on the first BWP,
determining that the communications device has second uplink data to transmit to the wireless communications network, and
transmitting, to the wireless communications network, the second uplink data within configured grant, CG, resources of the first BWP.

10. A method according to claim 9, wherein the CG resources are one instance of a sequence of periodically occurring instances of uplink communications resources of the first BWP.

11. A method according to claim 9, comprising
receiving, from the wireless communications network in response to the transmitted second uplink data, an indication that the communications device is to switch from the first BWP to the second BWP and is to transmit any further uplink data within the second BWP in accordance with the communications device based scheduling mode.

12. A method according to claim 1, wherein the determining whether the communications device is to operate in accordance with the communications device based scheduling mode in order to transmit the uplink data is based on one or more of:
a power class of the communications device,
a capability of the communications device,
a power headroom of the communications device, and
a level of pathloss between the communications device and the wireless communications network.

13.-16. (canceled)

17. A method according to claim 1, comprising, when switching between two BWPs,
deactivating the BWP being switched from and activating the BWP being switched to.

18. A method according to claim 1, wherein the first BWP is a default BWP.

19. A method according to claim 1, wherein the first BWP is an initial BWP.

20. A method according to claim 1, wherein the scheduling information is transmitted within a Physical Uplink Control Channel, PUCCH.

21. A method according to claim 1, wherein the uplink data is transmitted within a Physical Uplink Shared Channel, PUSCH.

22. A method according to claim 1, wherein the uplink data is equal to or greater than a predetermined size.

23. (canceled)

24. A communications device comprising
transceiver circuitry configured to transmit signals to and/or to receive signals from a wireless communications network via a wireless radio interface provided by the wireless communications network, and
controller circuitry configured in combination with the transceiver circuitry
to determine that the communications device has uplink data to transmit to the wireless communications network, and
to determine, independently from the wireless communications network, whether the communications device is to operate in accordance with a communications device based scheduling mode in order to transmit the uplink data, wherein if the communications device determines that it is to operate in accordance with the communications device based scheduling mode in order to transmit the uplink data, the controller circuitry is configured in combination with the transceiver circuitry, as the communications device based scheduling mode,
to switch from a first bandwidth part, BWP, of the wireless radio interface to a second BWP of the wireless radio interface for transmission of the uplink data, wherein the second BWP has a greater bandwidth than the first BWP and comprises a control resource and a data resource,
to transmit, to the wireless communications network within the control resource, scheduling information indicating that the communications device is to transmit at least part of the uplink data to the wireless communications network, and
to transmit, to the wireless communications network within the data resource, the at least part of the uplink data in accordance with the transmitted scheduling information.

25.-47. (canceled)

48. An infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to determine that the communications device, which is currently operating on a first bandwidth part, BWP, of the wireless radio interface, has uplink data to transmit to the infrastructure equipment, and
to determine that the communications device will independently determine whether it is to operate in accordance with a communications device based scheduling mode in order to transmit the uplink data, wherein if the infrastructure equipment determines that the communications device will independently determine that it is to operate in accordance with the communications device based scheduling mode in order to transmit the uplink data, the controller circuitry is configured in combination with the transceiver circuitry, in accordance with the communications device based scheduling mode,
to determine that the communications device will switch from the first BWP of the wireless radio interface to a second BWP of the wireless radio interface for transmission of the uplink data, wherein the second BWP has a greater bandwidth than the first BWP and comprises a control resource and a data resource,
to determine, from the communications device within the control resource, scheduling information indicating that the communications device is to transmit at least part of the uplink data to the infrastructure equipment, and
to determine, from the communications device within the data resource, the at least part of the uplink data in accordance with the received scheduling information.

49.-52. (canceled)
